(19) United States
(12) Patent Application Publication
(10) Pub. No.: US 2013/0000248 A1
(43) Pub. Date: Jan. 3, 2013

(54) METHOD AND AN EXTRUSION DEVICE FOR MANUFACTURING CLOSED-SECTION BEAM ELEMENTS

(76) Inventors: Pavlo Semenivskyi, Czechowice-Dziedzice (PL); Anatoliy Semenovskyi, Kiev (UA); Igor Didenko, Kiev (UA); Aleksandr Semenovskyy, Kiev (UA)

(21) Appl. No.: 13/634,691

(22) PCT Filed: Mar. 16, 2010
(86) PCT No.: PCT/PL10/00021

§ 371 Date: Sep. 13, 2012

(51) Int. Cl. B29C 47/78; E04C 3/28

(52) U.S. Cl. 52/843; 264/209.6; 425/206

(57) ABSTRACT

A closed-section beam element is provided, especially in a form of a tubular beam, manufactured of composite material containing comminuted and/or broken-up filing material, mainly wooden chips and particles, and thermosetting resin, wherein said beam element (10) has generally of longitudinal shape and having cross section of its external contour of any polygonal shape, or a circular or oval shape and/or of any irregular shape, preferably provided with projections and/or recesses arranged over the external surface of said beam element, and additionally said beam element has a central through opening (20) forming an internal through channel, preferably of a circular cross section, wherein surface of the internal through channel is provided with a continuous contour of at least one screw or spiral line (40) in relation to a centre axis of said beam element and extending, preferably, along full length of the internal channel along its central axis.

A method and extrusion device for manufacturing of said closed-profile beam elements from said composite material is also provided.

### FIELD OF THE INVENTION

The present invention relates to a method for manufacturing closed-section beam elements, especially hollow beams such as tubular beams, of composite material comprising filling material, preferably naturally occurring particle or fibre material, including material based on a wooden chips and/or comminuted or broken-up material, using a method of continuous extrusion. The present invention relates as well to a closed-section beam element produced by such a method and an extruding device for manufacturing, especially by the continuous extrusion method, the said closed-section beam elements of composite material comprising naturally occurring particle or fibre material, preferably a wooden comminuted and/or broken-up material. The beam elements produced using the method according to the invention are applicable as construction elements for manufacturing of packaging, furniture or in a building engineering, including supporting structures for construction industry, for example both during construction of few stories buildings and during finishing and repair works.

### BACKGROUND OF THE INVENTION

Manufacturing of different type elements used in building engineering and construction industry using wooden materials such as comminuted and/or broken-up wood material in a form of different size shavings, chips and wood pieces or particles, and also wood dust, which usually is a waste material from wood machining or wood processing, or from manufacturing wood products such as furniture, finishing boards, lining boards, etc., is known in the art. The known industrial production of elements made from shavings, chips and another wood waste materials have generally flat shape and usually are in a form of boards, such as particle boards, fibreboards, plywood, OSB or LSL boards, and elements composed of them, including beams produced by bonding in layers flat pieces of veneer using a glue agent.

Methods of manufacturing transport pallets comprising profiled elements of waste wood material such as wooden chips or particles are commonly known in the art. Flat profile elements, usually boards or pallets, are produced in industrial practice with such methods as moulding extrusion or pressing moulding. For example, in patent No. JP2008255280A, a method is disclosed by which a composition material comprising 51-70% by weight of wooden particles, usually shavings, chips or other fine particles and fibres of plant origin and wood dust, mixed with 5-15% by weight talcum powder and optionally no more than 1-5% by weight another additives, and from 20 to 45% by weight of synthetic resin as a binding agent, is extruded. Such composite material is injected into a mould and is pressed by means of a stamping die. According to another known solution, flat profile elements are moulding extruded from a material composed of a waste wood material in a form of fine wood particles and a thermosetting binding agent, such as profiled elements for transport pallets, according to U.S. Pat. No. 4,559,195. In this solution, the composite material is filled into an open flat mould by injection, and then it is compacted under different pressing pressures, to create projecting ribs on a surface of extruded board. Following that the extruded product is subjected to hardening treatment. It is also known from DE patent document No. 3321307A manufacturing method of compression moulding of profiled elements in a form of shapes, for example I-beams.

None of the above described manufacturing methods, known in the art leads to manufacturing of 3-D beam elements of closed-section or closed-profile, i.e. to elements provided with central opening/channel extending centrally along whole axial length of the elements, for example hollow tubular beams.

There were attempts made to manufacturing hollow closed-section elements of broken-up or comminuted wood wastes, usually different size shavings and particles, such as longitudinal tubular beams having different shapes of external contour, circular or polygonal, with circular central through opening. However, those attempts were finished at an experimental development stage. Attempts related to manufacture tubular beams of this kind through continuous extrusion by means of a screw extruder having appropriate structure, but the results were not satisfactory neither in respect of quality and strength of produced beams, nor smoothness and effectiveness of manufacturing process. Therefore none of the said solutions have exited beyond experimental phase up to now, and an industrial production technology of manufacturing process of tubular beams of that kind has not been developed. Those known experimental solutions were disclosed, for example, in patent publications No SU281811, SU1110061A, SU1562147A1, SU914321, SU415169, SU912536, SU1172716A, SU577136, SU11213237A. A composite material comprising shavings with different shapes and sizes, which are mixed with a thermosetting binder is extruded using a screw extruder, said composite material is delivered into an extruding channel of the screw extruder. In the channel a rotatable extrusion screw-shaft, having constant diameter along the whole length of the extruding channel and having threads of the screw-line arranged all over its external surface is centrally located. Said composite material is extruded by being firstly subjected to compacting or densification by compressing under high temperature and pressure conditions in the zone of extruding channel having walls converged in the extruding direction, i.e. having cross section of the channel in that zone decreasing, and then the formed composite material is hardened through heating to a hardening temperature in the zone of the extruding channel having invariable constant cross section.

In the above mentioned patent publications, the extruded composite material is delivered to a loading zone of the extruder by delivering it to a hopper and then distributing it by means of different structure distributing devices. It may be also delivered from a side by a single feeding screw which cooperates with a distributing device in a form of rotational disk. Heating units are located in the extruder body, adjacent to an extruding channel. In order to obtain an appropriate ratio of densification or compactness of the extruded composite material to an appropriate density, in a compacting zone another means are provided, behind converging cross section of the extruding channel, such as, there is provided a segment of the extrusion channel having constant cross section but having changing pitch of the screw threads line in this segment of the compacting zone, decreasing in a direction of extrusion. In further embodiment, additionally the height of the threads of a screw line is decreasing in the direction of extrusion. As said above any of the disclosed solutions neither leads to achieving satisfactory results, nor has been implemented into manufacturing practice.

### SUMMARY OF THE INVENTION

A technical problem being solved by the present invention, is to provide industrial applicable method for manufacturing of closed-section beam elements, such as structural elements, which are manufactured at minimal possible material consumption, by means of continuous extrusion of composite material comprising comminuted and/or broken-up wooden material using a screw extrusion device, wherein beam elements having uniform external surface can be obtained, as well as having good mechanical strength and stable physical properties. At the same time providing good economical efficiency and effectiveness of such manufacturing method under conditions of industrial production mood of products are assured.

Another objects of the invention is to provide an extruding device for continuously manufacturing profiled closed-section beam elements, which device being suitable to work under condition of industrial production mood, as well as providing closed-section profiled beam elements having any desired shape of external surface and cross section of external profile shaped as any polygonal or circular tube, with a central axial through opening.

In one aspect the present invention provides a method for manufacturing closed-section beam elements, especially tubular beams, of a composite material comprising at least a filling material and at least one binding substance, wherein the filing material contains particles and/or fibres of natural origin, preferably comminuted and or broken-up woody material originating from waste wood, and at least one binding substance containing a thermosetting resin, said method comprising continuous extrusion of prepared composite material by means of an extruding device such as a screw extruder which being provided with a forming channel and a rotational screw shaft arranged therein, said method including treatment stages which are carried out consecutively one following another, such as a loading phase, a compacting and forming phase of said composite material, in which phase said composite material is subjected to densification by compacting to a predetermined density and formed to a desired shape and a hardening and annealing phase, in which phase said formed shape and size of said beam element are fixed and a desired hardness is given to said beam element. Said composite material after being loaded to the extruder in said loading zone is moved along said forming channel of said extruder and is subjected to densification by compacting in said compacting zone by means of decreasing a volume of the said channel space defined between threads of a screw line provided on said screw shaft and/or by means of decreasing a volume of the space defined between surface of said screw shaft and a surface of said forming channel.

Another aspect of the present invention relates to a closed-section beam element, especially in a form of a tubular beam, manufactured by the above presented method and containing comminuted and/or broken-up filing material, mainly wooden chips and particles, and thermosetting resin, said beam element has generally longitudinal shape and having cross section of its external contour of any polygonal shape, or a circular or oval shape and/or of any irregular shape, preferably provided with projections and/or recesses arranged over the external surface of said beam element, and additionally said beam element has a central through opening forming an internal through channel, preferably of a circular cross section, wherein surface of the internal through channel is provided with a continuous edge in a form of a contour of at least one screw or spiral line.

In another further aspect of the present invention an extruding device is provided for manufacturing of said closed-section beam elements, of a composite material containing at least one binding substance and filling material comprising particles of natural origin, especially wooden chips and/or short fibre material, which device is provided with a housing, in which a longitudinal internal forming channel is arranged and surrounded by an external body, inside said channel a rotational screw shaft is provided that is rotationally supported and arranged centrally along central axis of the forming channel, which screw shaft is provided with screw threads arranged on its external surface along at least one screw line, said screw shaft being connected at one of its ends to a drive unit, and further heating means is located in the device body. Said extruding device comprising consecutively located treatment zones, a loading zone, a compacting zone and a heat treatment zone. In said compacting zone, at least at some segment, a volume of said forming channel space defined between said threads of a screw line of said screw shaft decreases and/or a volume of the space limited between surface of said screw shaft and a surface of said forming channel decreases. Furthermore, said device is provided with at least two or more feeders delivering composite material to said loading zone.

Further aspects and embodiments of the present invention will become apparent from the following detailed description and drawings.

### BRIEF DESCRIPTION OF DRAWINGS

The present invention presented in embodiments will be shown and described further, making reference to the attached drawings, in which:

FIG. 1 presents a side view, partially in section, of a beam element according to the invention;

FIG. 2 presents a sectional view along line A-A in FIG. 1;

FIGS. 3-10 are sectional top views of beam elements according to different embodiments of the invention; and

FIGS. 11 and 11a is a schematic view of an embodiment in one of variants of extruding device according to the present invention, wherein FIG. 11a showing a part of exemplary screw shaft of one embodiment of the present invention.

### DETAILED DESCRIPTION OF PREFERRED EMBODIMENTS

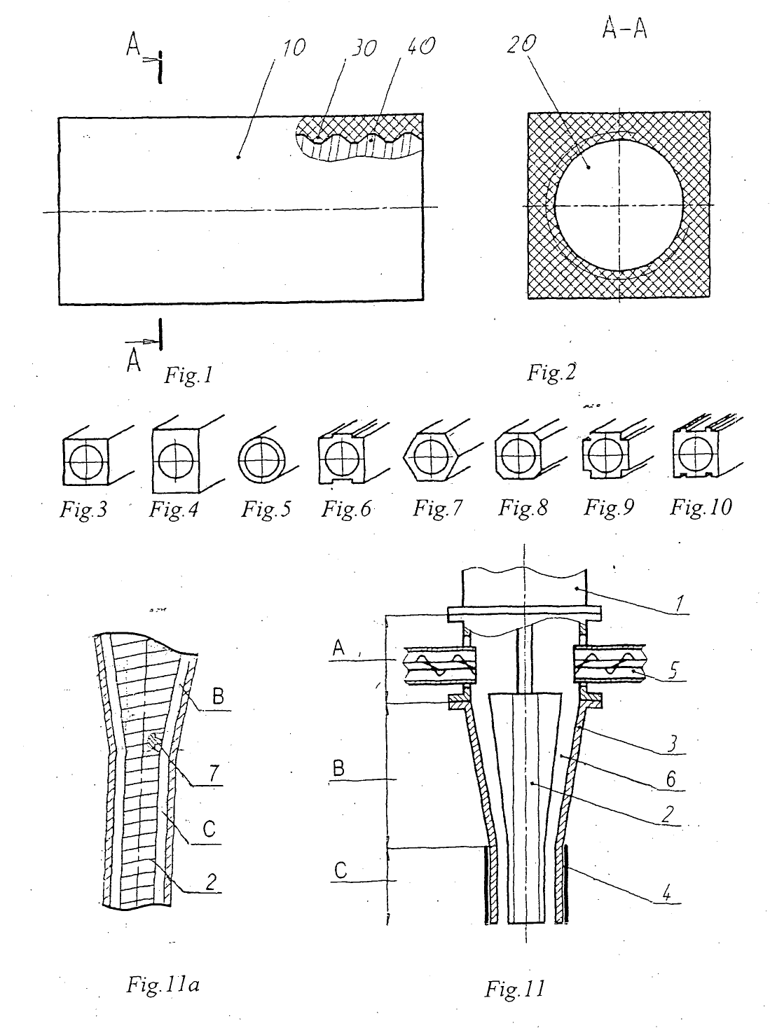

A method for manufacturing closed-section beam elements 10, which are exemplary presented in FIGS. 1 and 2 according to one of preferred embodiments of the invention, particularly relates to manufacturing of elements having closed-profile in form of tubular beams, having central opening 20 extending along longitudinal axis of the beam element 10, said opening has generally circular cross section whereas an external profile of the beam element having a cross section of any suitable shape such as, polygonal, circular, body of revolution or any other possible shape. A closed-section beam element 10 according to the invention, as illustrated in FIG. 3-10, can have especially a cross section of its external profile in a shape of rectangle, square, hexagon, octagon and another polygon, said external contour of a profile can comprise longitudinal recesses and/or projections extending generally along central longitudinal axis of the beam element, extending all over or at least partly on its external surface, which projections and/or recesses can be arranged, for example, symmetrically or asymmetrically at diametrically opposite surfaces of external walls of said beam element. Said beam element 10 according to the invention can have a shape of a “star-piece type” beam with removed quadrants or a “tongue-and-groove” type or a multiple “tongue-and-groove” type. Projections and recesses can be arranged at corners, on sides and/or in the centre of corresponding side surfaces, and further in the form of a complementary pattern, i.e. with projections arranged at one side surfaces and recesses of the corresponding shape arranged at the opposite side surface (FIG. 6, FIG. 10). The beam element 10 according to the one embodiment of the invention comprises lengthwise central opening 20, particularly of an essentially circular cross section, a surface of which is provided with projections 30 in a form of threads 40 of a screw line, said projections extending along longitudinal axis of the opening. There are provided embodiments, in which a screw line is a single-, double- or more-threaded. The cross section area of said internal through opening 20 ranges from about 30% to about 80% of entire cross section area of said beam element.

An inventive method for manufacturing closed-section beam elements, i.e. having closed-profile, includes the step of extruding of beam elements 10, especially in form of tubular beams, using continuous extruding process by means of screw extruding device, preferably screw extruder of specific design, from natural origin composite material containing mineral or plant raw materials and binding substances, especially thermosetting binding substances. Said extruding process according to the invention includes directly one after another following steps, which are carried out in suitable zones of the extrusion device, namely: a loading step of the prepared composite material into the extruding device, a densification by compacting or compressing and forming stage of the composite material and the step of heat processing and distressing soaking, i.e. hardening and annealing of the formed beam element 10.

A basic material for preparing of the extruded composite material is a filling material, which can be material comprising chips, particles or fibres from mineral raw materials and/or fibred or comminuted and/or broken-up material of plant origin, but particularly chips, pieces and particles of wood or wood-based material, such as exemplary broken-up waste material from production or processing process in wood industry or non-marketable wood, as well as another cellulose particles and fibres, and also fibres from stems and another parts of plants. Said filling material on a basis of mineral raw materials can contain fibre elements, glass fibres, slag wool and similar fibres or particles. A selected mineral material which is chemically inert can be used as a component of filling material, for example an asbestos material. According to the invention, filling material can be of one kind of above mentioned particle material, or a mixture comprising two or more material selected from above mentioned particle or fibre materials, both mineral and plant origin.

It is possible to add cement or gypsum additives, which can have additional function as binding substances giving specific functions and features to closed-profiled products, advantageously beams.

In one embodiment of the inventive method which is especially preferred and advantageous from point of view of costs and accessibility of raw materials as filing material comminuted and/or broken-up wood material is used, including fuel wood, industrial chips, waste wood from sawmills and wood processing factories, or from industrial production woody products, such as furniture and furniture elements, plywood and different kinds of boards comprising wood-based material, and also waste wood from tree felling in a form of particle material, for example shavings, chips, sawdust, board cuttings, strips or strip cuttings in a form of a coarse waste pieces or fine-particle wastes.

In further one embodiment, the wood which is broken up to chips and/or shavings is usually used as a basic kind of a raw material, however, a shape and a type of used shavings considerable influence a quality and mechanical features of produced beam elements, for example such features as surface roughness, mechanical strength, permeability for fluids, especially for water, steam and binding substances, as well as swelling ability.

Wood from different kinds of hardwood and softwood, such as a spruce, pine, fir, larch, cedar, beech; oak, ash, lime, alder, maple, birch, aspen, poplar etc., can be used for manufacturing of inventive closed-section beam elements 10 but a sort of used wood type has considerable influence on a quality as well as mechanical and physical properties of produced elements. For example, beam elements produced of a filling material comprising pine wood have the highest strength, while the lowest strength have beams of filling material comprising beech wood. The highest ability to swelling have elements produced of material comprising pine wood, while the lowest ability to swelling have elements produced of material comprising beech wood.

A sort and quality of shavings constituting comminuted wood material used as a filling material also influence quality and, especially, mechanical strength of manufactured beam elements. Said quality of beams is much higher when chips and shavings having as much as possible smooth and even surface are used in the manufacturing process, since surface roughness of particles/shavings increases adsorption (absorption) of a binding substance by wood. For rough shavings and particles the degree of binding is less, so strength of adhesive/binding joint decreases and obtained product is more susceptible for de-lamination of a structure that leads to weakening of the mechanical strength.

One of additional factors, connected with a wood type, influencing a quality of beam elements manufactured of comminuted wood material are hydrophilic properties and a permeability for fluids of a given wood type, especially for fluid binding substances, i.e. ability of different fluids to flow through material. The higher permeability of woody material for fluids, the more substances is adsorbed by it. The main wood types in respect to increase of their level of permeability for fluids are as follows: a softwood with a duramen, such as a larch, a cedar, a pine; a hardwood with duramen, for example: an oak, an ash, a poplar; a softwood without duramen, such as: a fir, a spruce, and a hardwood without duramen, such as e.g.: a beech, a lime; a hardwood with sapwood, such as e.g.: an alder, a maple, a birch. The most suitable wood types for manufacturing beam elements according to the invention from point of view of their permeability for fluids are a pine and a cedar, but a poplar wood and softwood, mainly a pine-wood and spruce wood, can be particularly preferred as a filling material.

Further, from point of view of manufacturing process of beam elements according to the present invention acidity i.e. pH-value of the particle wood constituting filling material is also important. During a manufacturing process an amount of a binding substance as used is determined taking into account pH of type of wood, to provide a suitable hardening of a binding substance during a fixed time period, which is determined in advance. The determination of a hardening/curing time of a binding substance and a control of that hardening time is especially difficult if as a filing material the mixture of particle wood materials of different wood types is used, each having different pH values. So, in preferred embodiment of the method according to the invention one sort of wood or a mixture of different types of wood having a fixed constant composition is used.

Mechanical properties of beam elements manufactured by the present invention are also influenced by quality of filling material as used, particularly by an amount of a bark and a decay contained in said woody material, this relates to especially wastes from production process or wastes from sawmill. In the case of a great amount of a decay in said woody material it should be removed before delivering to a manufacturing process.

Further, on mechanical strength of the beam elements, and also on parameters of extrusion and whole pressing process during inventive manufacturing of beam elements humidity of woody material used has influence. For example, a humidity of wastes from woodworking can be 40-60%, whereas in case of a sawmill wood, which is delivered by fluming, the humidity can even reach 120%, when in case of wastes from a furniture production a humidity can be about 12%. Higher wood humidity has negative influence on a structure of manufactured beam elements leading to creating of bubbles in beams. However, insufficient humidity of shavings, as porous-capillary bodies, leads to significantly increased absorption of binding substance, as a result of which a significantly less amount of a binding substance, participating in a binding and gluing process remains on external surface of chips and shavings, that in turn has negative influence on binding force of a filling material and thus on mechanical strength of manufactured beam elements. At a low humidity compacting of a filling material is more difficult and higher compressing pressures are required, what entails increased power consumption. Additionally, unevenness of humidity distribution in a filling material leads to unevenness in thickness and density of manufactured beam elements.

Taking into account the aforesaid in the present invention, it is especially preferred when humidity of chips and shavings used in a manufacturing process of inventive beam elements is in the range 2-5% by weight of total weight of chips and shavings, but a composite material designed for extruding can have humidity up to 18% by weight, wherein it is assumed that thermosetting substance as added comprises about 50% of a glue dry matter and 50% water.

Since, in the method according to present invention the basic raw material applied as a filling material are comminuted wood material in form of chips, shavings and fine particles, shapes and sizes of those particles and/or shavings have critical influence on strength features of manufactured, beam elements, such as mechanical strength for longitudinal and transverse loadings, as well as on roughness of a surface and uniformity of a structure and colour distribution. Shavings or chips having generally flat, longitudinal shape and smooth surface are mostly preferred because they provide manufacturing of beam elements having a highest mechanical strength. Using short and three dimensional twisted shavings a lower mechanical strength of manufactured beams is obtained. A lower mechanical strength is also obtained in case of using coarser shavings, this larger thickness of shavings leads to a higher roughness of beam surfaces. However, the less thickness of shavings, the higher of their brittleness, leading to dust creating, then to decreasing of mechanical strength of beam element. Generally, mechanical strength of beam elements increases with increasing length of shavings applied and it decreases with increasing shavings width. According to further embodiment fibre materials comprising short longitudinal fibres or generally fibres having needle structure are used.

According to another further embodiment of the present invention, different types of shavings, including flat shavings having following dimensions: thickness 0.15-0.45 mm, width from 0.25 to 12 mm and length from 0.25 to 40 mm; needle shaped shavings having dimensions: thickness 0.15-0.45 mm, width from 0.25 to 2 mm and length from 0.25 to 40 mm; fine shavings having dimensions: thickness 0.10-0.25 mm, width from 0.25 to 2 mm and length from 2 to 8 mm; fibre particles having thickness to 0.25 mm, width to 0.25 and length to 6 mm; also sawdust and processing woody flour and grinding flour can be applied under the inventive manufacturing method of beam elements. Preferred dimensions of woody particles and shavings used in the method according to the present invention are in the following range—thickness 0.2-0.5 mm, width 0.5-5 mm and length 5-20 mm. Addition of relatively small amount of sawdust and woody flour not exceeding 20% by weight in respect to a dry matter of a filling material can be acceptable.

In the method according to the present invention, for preparing composite material for extrusion at least one binding agent and/or substance is added to the filling material composed by shavings, comminuted wood particles and woody dust, and mixed therein. Such one or more binding agents or binding substances are applied at a surface of shavings, chips and woody particles, the process of which is also referred as a tarring of shavings. In a preferred embodiment of the invention a binding substance/agent is sprayed all over surface of shavings and particles of the filling material.

According to the invention, for manufacturing of the composite material for extrusion resins are usually applied as binding substances/agents, namely such resins that under influence of heat and pressure are able to join, bind or glue together particles of filling material comprising woody particles and shavings, in a stable manner. In particular, thermosetting resins are preferred, which when heating pass initially from liquid to suspension state, and then irreversibly to a solid state, which thermosetting resigns are selected from groups including urea-formaldehyde resins, phenol-formaldehyde resins, melamine-formaldehyde resins and urea-melamine-formaldehyde resins, as well as polyether resins. By binding of filling material particles using binding substances based on above mentioned thermosetting resins a good joint is achieved, and beam elements demonstrate a high stiffness and mechanical strength. For manufacturing beam elements having higher resistance for atmospheric conditions, especially for water and temperature changes, phenol-formaldehyde resins are most suitable, which additionally are resistant to influence of biological agents, fungi, moulds, insects, etc., but which are more costly than urea-formaldehyde resins and they need a longer pressing time, that in turn is connected with increased production costs. In connection with the above when manufacturing beam elements for specific applications, for example in building engineering, applying of phenol-formaldehyde resins is preferred, as well as urea-melamine-formaldehyde resins. However, urea-formaldehyde resins, which give relatively worse operational parameters to beam elements manufactured using them, are cheaper and much more efficient in production.

Optionally additive substances can be added to the composite material for extrusion of the above described basic composition consisting of filling material and binding substance, such as catalysts, which accelerate reaction, lubricants and other additives, which give specific properties to manufactured beam elements, depending on requirements connected with their applications, wherein composite material can comprise one or more additives. For example, such additives can be selected from group comprising hydrophobic additives, such as paraffin, ceresine, petrolatum, or wax, which are added to shavings/chips during a manufacturing process in a form of a melt or emulsion or in a form of a component of a resin. Optionally; aseptic additives such as pentachlorophenol in amount 1-2% by weight of dry matter of filling material, or sodium fluoride and sodium fluorosilicate and mixture of sodium fluorosilicate with copper (II) sulphate pentahydrate or zinc chloride, and further additives for reducing friction during extrusion can be also applied. In case of specific applications and requirements connected with a fireproofness, additives which increase a fire resistance could be applied to binding substance, especially antipyrenes such as orthoboric acid, orthophosphoric acid or their salts and mixtures, also with another substances, for example with zinc chloride. Composite material for extrusion can comprise as well some amount of a hardening agent.

The amount of binding substance as used and mixed with filling material and the way of its application into the filing material has critical influence both on a quality and mechanical and physical characteristics of beam elements produced, as well as on production costs. In the method of the present invention one of important factors is a thorough and accurate mixing of a composite material in the manner providing uniform distribution of binding substance/agent over a surface of filling material particles, particularly chips and shavings, that is obtainable with difficulties because a volume of a binding substance/agent is relatively low comparing to a volume and especially external surface of filling material particles.

In order to cover particles and shavings with continuous layer of binding substance, preferably gluing substance, it is necessary to fill surface irregularities of shavings and particles with such substance, that causes increase in consumption of relatively expensive binding substances, resulting also in higher production costs. To reduce binding substance consumption i.e. necessary amount of binding substance and to production costs reduction, the binding substance is distributed by droplet method over a surface of filling material particles. Namely, instead of continuous coating application a form of drops is used, as a result of which gluing of particles and shavings in spot gluing sites distributed over their surface is achieved. In one of embodiments, at least one binding substance/agent in the form of drops is added over surface of filling material particles through spraying method. Such application method in drops leads to obtaining equally effective and sufficiently mechanically strong gluing of composite material, at reduced costs, provided that binding substance is very precisely distributed over surface of particles and shavings, and thus proper mixing of composite material consisting of filling material and binding substance can be assured according to technical requirements and technology. In the present invention, the composite material has generally binding substance content from about 4% to 30% by weight, consisting of above mentioned types of resins, depending on humidity, preferably after converting to a dry matter of resin in amount from 2% to 15% by weight in relation to a mass of a completely dry filling material, preferably completely dry shavings, depending on a type and designation of manufactured beam elements. By such proportions of binding substance content in composite material it is preferred to apply filling material particles in form of shavings of humidity not higher than 18%.

The most responsible step of the process in a method of manufacturing of closed-section beam elements i.e. having closed profile according to the invention is an extrusion operation during which operation the composite material prepared in above described manner is subjected to densification by compacting (pressing) and formed to a finished product on which in further stage hardening and annealing are performed to relieve stresses which were created in extruded beam element, following which a trimming on size is carried out. That stage of the process has critical influence both on quality of manufactured products and on productivity. The composite material, prepared using above described components, in form of a mixture consisting of filling material, preferably comminuted and/or broken-up woody material, and binding substance with optional additives and some amount of air and water, a presence of which results from the nature of mixed components of composite material and process of their mixing, is supplied to a loading zone A of extrusion device 1, usually screw extruder having specific structure. Supply of composite material is usually realized by means of at least one feeder 5, such as selected from: a belt feeder, a scraper feeder, a screw feeder, a bucket feeder, a vibration feeder. In preferred embodiment there are at least two screw feeders 5 arranged at opposite sides of the loading zone A, but four or more screw feeders can be possible, as well as another way of feeding composite material to a loading zone can be used. In case of filling material which is a loose material it is also possible using gravitational supply of composite material, that is particularly advantageous if an amount of a binding substance in a composite material is relatively low, ranging from about 3% to 30% by weight. During that stage, in embodiment of the invention composite material is, optionally, preliminary heated up to a temperature about 40-60° C. before a right pressing.

Afterwards, under simultaneous action of heat and pressure which are delivered from outside, usually by means of a heating unit 4 arranged in a body of a extrusion channel 6, and additionally, optionally, also in a screw shaft 2 inner channel, a composite material is subjected to densification by compacting, in other words pressing, and forming (shaping) in a compacting zone B of extrusion device. So, during compacting the humidity, the amount of air and the volume of a composite material are decreased, and particles of filling material covered with a binding substance achieve a random orientation in a volume of material and are brought to a contact one with another, as well as with drops of binding substance arranged between them. As the pressure in the compacting zone B increases woody particles are deformed and cross together, and a contact surface between them increases that results in increasing of a binding surface, advantageously a gluing surface. Increase in a contact surface is associated with increasing of molecular adhesion forces, and that both factors have influence on increasing of a binding (gluing) strength of particles in filling material, and thus on higher strength of the manufactured beam element. A pressure value is selected taking into account physical features of filling material being pressed i.e. a mixture of different particles and shavings and possibly fibres, and also the pressing conditions.

If filling material comprises greater content of coarse shavings, larger compressing forces are required, so higher pressing pressure is needed to overcome a resiliency and stiffness of mostly coarse shavings and to prevent re-deformation (a partial return) of the formed beam to a previous shape under decrease or complete relieve of a pressing pressure, after exiting extrusion channel. Relatively less pressing pressure can be used in case of composite material comprising, for example, considerable content of shavings of a birch wood, since they exert a small resistance force in a tangent and radial directions during pressing, while shavings of softwood exert larger resistance forces during compressing in a transverse direction (across fibres), and so they require larger pressing pressures during compacting. The pressing pressure value depends also on humidity of shavings; the higher humidity, the lower pressures are required. Pressing pressure necessary value is also decreased if a temperature of walls of a extrusion channel of an extruding device is increased, what can be explained by increasing plasticity of a shavings mixture and by decreasing in internal stresses at a higher temperatures. After initial compacting of a composite material consisting of a mixture of binder and shavings and/or woody particles and obtaining a suitable shape of the formed composite material, i.e. obtaining a preliminary deformation of shavings/chips, the shape is maintained and by following growth of a temperature and pressing time relaxation of stress takes place, i.e. relieve of internal stresses which was created during initial phase of compacting of composite material, whereas the formed composite is warmed up and dried, and thus resilient compressing changes to a plastic compression (pressing) stage, during which the formed composite material takes a predetermined final shape, structure and density. In compacting zone B the composite material is heated up to a temperature not exceeding 100° C., preferably 60 to 100° C., that is maintained at that level, whereas a pressing pressure is maintained in a range from 2 MPa to 10 MPa, depending on a density of an extruded composite material and desired strength of a final beam element.

In embodiment of the invention composite material which is fed to the loading zone A is conveyed along a forming extrusion channel 6 of an extruding device and in the compacting zone B is subjected to densification by compacting and compressing by means of decreasing volume of the forming channel 6 between screw threads 7 of a screw line arranged on the screw shaft 2, and by means of decreasing volume of a forming channel 6 space determined by external surface of a screw shaft 2 and a surface of walls of a forming channel 6. Compacting of a composite material can be carried out in one embodiment of the invention both in transverse and longitudinal (axial) direction in respect to axial conveying direction of material in forming channel 6 of the extrusion device, i.e. in relation to a longitudinal centre axis of the extruder. Compacting can be performed by designing extruder channel having continuously decreasing cross section i.e. by providing walls of extruder channel 6 converging in said extruding direction (a transverse direction compacting step). In that case external surface of a forming channel 6 can have shape of a truncated cone or a truncated pyramid, which vertex is faced to a movement direction of composite material during extrusion. Such compacting can be also carried out by means of using variable pitch of threads 7 of a screw line arranged on screw shaft 2 of said extruder, decreasing in extruding direction (longitudinal direction compacting step). In one embodiment of the present invention the zone of decreasing cross section of the forming channel 6 is coincided with the zone with decreasing pitch of screw threads of the screw shaft 2 in the extruder. In such a case simultaneous compacting in a transverse and lengthwise direction in a compacting zone B having converging walls of pressing channel and decreasing pitch of threads of screw line on screw shaft 2 is carried out. It is also possible to accept a structure, in which those zones coincide only partly, as an example at initial stage of compacting of composite lengthwise direction compacting is carried out, at constant cross section of a extrusion channel but at decreasing pitch of threads of a screw line, and then additionally compacting in transverse direction takes place, i.e. using decreasing cross section of a extrusion channel with converging walls of the channel during which a pitch of screw threads can be maintained constant or can be variable, at least at some segments. According to one further embodiment of the inventive method, composite material is compacted in a lengthwise direction, consistent with a direction of a movement of the composite material in a forming channel of the extruder at a density compacting ratio ranging from 1.5 to 2.5 in relation to an initial density of the composite material, i.e. at an entrance of compacting section B, while heating to a temperature in the range of 30-60° C., as well as composite material is compacted in a transverse direction at a density compacting ratio ranging from 2 to 4 of an initial density, while being heated to a temperature not exceeding 100° C. After finishing that stage, i.e. the stage of compacting (pressing) and forming in a compacting zone B, a formed composite material is passed, transported by means of threads of a screw shaft 2 in a forming channel 6, to a next zone of extrusion device, i.e. to a heat treatment and annealing zone C, in which a binding substance included in composite material is hardened and condensed, and so that durable and irreversible bonds are formed between binding substance and particles of filling material, woody particles in preferred embodiment, i.e. adhesion, and also a durable bonds (junction) of particles of binding substance together (cohesion) are formed. That hardening or condensation of binding substance is carried out under an influence of heat delivered in a determined temperature, which is higher than the pressing temperature in the compacting zone B, while heat is delivered to composite material by means of heating units 4 arranged in heated walls of a extrusion channel or additionally also through an internal channel in a screw shaft 2. After hardening and annealing, a finished closed-section beam element is provided having a desired external shape and a desired density of a wall in range from about 600 kg/m³-1100 kg/m³, advantageously from 800 kg/m³ to 1000 kg/m³, said preferable density of a whole profiled element ranges from 300 to 550 kg/m³ depending on the density of the wall and a size of an internal through opening. During hardening stage a composite material is heated up to a temperature from about 100° C. to 250° C., optionally from 100° C. to 150° C., depending on the content of binding substance, a sort of a hardener, etc., in a heat treatment zone C of the extruder.

Following a heat treatment and annealing stage of the extruding process, a finished beam element having required, predetermined shape and density and another physical parameters is ready to exit the forming channel in a hot state or after an optional cooling, and directly after exiting of the extruder it is cut to suitable longitudinal size, and then it is subjected to cooling by means of natural or forced circulation of a cooling air, which can flow not only at outside of an element but also through its internal opening, cooling it from inside.

Extrusion device of the present invention for manufacturing closed-section beam elements 10, especially tubular beams, by a method described above, comprises generally a housing, in which an internal longitudinal forming channel 6 is located, said channel is enclosed by an external body 3, wherein inside the channel a rotating screw shaft 2 is arranged extending centrally along centre axis of the channel 6. An external contour of a surface of said forming channel 6 can be optional, for example polygonal or circular, corresponding to a shape of manufactured beam elements desired and further the surface of the channel 6 in one of embodiments is provided with edges extending along an axial length of the channel 6. The screw shaft 2 has a circular cross section and is provided at its external surface with at least one cut line of screw threads 7 which has a contour of a screw line, said shaft is coupled at its one end by means of a power transmission unit, with a driving device 1, preferably, a motor. Inside of a screw shaft 2 can be arranged central inner through channel, for example for accommodation of heating or cooling means, or means for circulation of heating or cooling medium. The extruding device has generally three sections, treatment zones, which are arranged consecutively one following another, wherein said forming section, according to the invention, is arranged before a hardening and annealing section, i.e. inversely in respect to common extruders for plastics, known in the art. In the extrusion device of the present invention, starting from device side facing a power transmission unit, the loading zone A of an extruder is arranged, the next is a compacting zone B located, in which a process of compacting and pressing and forming of composite material is carried out, and then, on exit side of the forming channel 6, a heat treatment zone C for hardening and annealing of formed elements of composite material is arranged. In a body 3 enclosing the forming channel 6 heating elements 4 of a heating unit 4 and optionally a cooling unit are arranged. In one of embodiments, in a screw shaft 2 additional heating means, and optionally also additional cooling means, are provided, said heating units 4 and cooling means could be any known type, such as means for circulation of heating fluid, for example pipe or panel heat exchangers with a circulation of heating fluid (liquid or gas) or heaters with blowing of a hot gas and/or electric heating elements, for example resistance or induction heating elements. Cooling units or means could include, for example, heat exchangers with a circulation of a cooling fluid and/or blowing of a cooling gas, preferably air.

Loading section A, in which a cross section of a inner channel of the extruder is, preferably, largest, has at least two or more, for example four, loading openings, located opposite one another, at opposite sides of a forming channel 6, into which feeders 5, such as exemplary screw feeders, for delivering of an extruded composite material, are provided. In one embodiment more than two loading openings and more than two screw feeders, preferably four or more loading openings and screw feeders can be provided. However, feeders according to the invention can be any another type, such as belt feeders, bucket feeders, scraper feeders, vibration feeders or others. In a loading section A, screw shaft 2 of extruder has usually a constant diameter of its cross section, while a line of screw threads of a screw can have not only constant pitch, but in an optional preferable embodiment at least at a part of length of the loading section A, a pitch of threads of a screw line can be variable, mainly decreasing consecutively in transfer direction of extruded composite material during extrusion, i.e. in a direction towards compacting section B. A height of threads of a screw line of a screw shaft 2 can be constant through the whole extend of loading section A of the extruding device, but optionally it could be larger than in remaining sections of the extruder, such as compacting section B and hardening section C, but the height could be also variable as well as equal the height in other sections.

A contour of a screw line of screw threads provided on screw shaft 6 in loading section can have, in one embodiment, sharp external edge, while in a compacting and forming section of extrusion device a contour of an external edge of a screw line of threads 7 is preferably less sharply ended, optionally it can be flattened or rounded. In one preferred embodiment, in compacting and forming section B, at least at some segment, a volume of extrusion forming channel 6 space, defined between threads 7 of a screw line of a screw shaft 2, is decreased and/or a volume of a space defined between a surface of a screw shaft 2 and a surface of a forming channel 6 at least at some segment is decreased. In one embodiment the compacting zone B, a cross section of the forming channel 6, at least at a part of its extension, and preferably at whole length of the section is continuously decreased, whereas external walls of a forming channel 6 are shaped as convergent in a moving direction of an extruded composite material. An external contour of surface of said forming channel 6 in the compacting zone B, i.e. a surface of forming channel 6 in compacting zone in further embodiment of the invention, determines a shape of truncated cone or truncated pyramid, a vertex of which facing in a moving direction of an extruded composite material during extrusion process. Optionally, in compacting section B, at least at a part of its extension, a pitch of threads 7 of a screw line arranged on screw shaft 2 is continuously decreasing in a moving direction of composite material.

A height of threads 7 of a screw line can be optionally constant or variable, particularly it can decrease. In one embodiment of said extrusion device of the present invention, screw shaft 2 of the extruder in compacting zone B has, at least at a part of extension of that zone, and preferably in a whole zone, a variable cross section, said diameter of a cross section of the screw shaft 2 is continuously decreased in the direction of transporting and moving of composite material during extrusion. By preferred embodiment, segments of a compacting zone having a decreasing cross section area of a forming channel 6 and a decreasing diameter of a cross section of screw shaft 2 are at least partly coincident one another, and preferably are coincident at the whole extension of that zone B. In addition, in one embodiment of the present invention, those segments could at least partly coincide also with segments of said compacting zone having decreasing height of threads and a pitch of threads of the screw line of screw shaft 6. Other embodiments of a compacting and forming section B are also possible, wherein in a part of forming channel 6 having decreasing cross section area and converged walls of the cross section of a screw shaft 6, at least at some segment, remains constant. A contour of a screw line of screw threads in a compacting and forming section B can be configured with a constant pitch of threads or optionally with variable pitch of threads, said pitch is decreasing in the transport direction of an extruded composite material during extrusion treatment. In further embodiment, a pitch of threads of the screw line of screw shaft 6 remains constant at the part of compacting section B, in which cross section of a forming channel 6 is variable, i.e. is continuously decreasing, but optionally it can be variable at that part. However, a variable pitch of a screw line of a screw shaft 2 can be provided at that part of said screw shaft having constant cross section and/or having also a variable cross section, and it extends in a constant or variable cross section segment of a forming channel 6. In one embodiment, in the segment of forming channel 6, which has converging walls and a continuously decreasing cross section, both a cross section area of screw shaft 2 and a pitch of threads of a screw line are decreasing in a moving direction of composite material during extrusion. Optionally, a height of threads can be variable, preferably it can decrease.

Forms and embodiments described above in relation to a structure of the compacting and forming section B of inventive extruding device ensure compacting and densification of composite material delivered to the device, both in lengthwise and transverse direction in relation to a centre axis of the screw shaft 2 of extruding channel 6.

In a heat treatment section C, i.e. in a hardening and annealing section of the inventive extruding device, both the cross section of forming channel 6 and the cross section of screw shaft 2 remain constant, similarly, a pitch of threads of a screw line of screw shaft 2 is usually constant all over extension of that section. Additionally, an external edge of the screw line of threads can be ended by a flattening or it can be rounded. Further, a screw line of screw threads can form one thread winding, but it is possible also to use double-threads winding with two screw lines of threads, three-threads winding with three screw lines of threads, as well as four-threads winding with four screw lines of threads arranged at a surface of a screw shaft.

An external shape of forming channel 6 in the heat treatment section C corresponds to the shape of manufactured beam element, which will be obtained, so that it can be shaped as a polygonal, for example rectangular, square, hexagonal, octagonal or another polygonal or circular, elliptical or oval one, and additionally it can comprise projections or recesses, for example it can have a “star” type shape or a “tongue-and-groove” type or a multiple “tongue-and-groove” type, it can be provided with recesses or chamfers in corners, and also single recesses or projections, arranged at a circumference of forming channel surface in any locations, usually along axis of a forming channel.

1. A method for manufacturing closed-section beam elements, especially tubular beams, of a composite material comprising at least a filling material and at least one binding substance, wherein the filing material contains particles and/or fibres of natural origin, preferably comminuted and/or broken-up woody material originating from waste wood, and wherein at least one binding substance contains a thermosetting resin, said method comprising continuous extrusion of prepared composite material by means of an extruding device such as a screw extruder which being provided with a forming channel (6), and a rotational screw shaft (2) arranged therein, which method including treatment stages which are carried out consecutively one following another, such as a loading phase, which is carried out in a loading zone (A) of said screw extruder, compacting and forming phase of said composite material, in which phase said composite material is subjected to densification by compacting to a predetermined density and formed to a desired shape, which stage is carried out in said compacting zone (B), and a hardening and annealing phase, in which phase said formed shape and size of said beam element are fixed and a hardness is given to said beam element, which stage is carried out in a heat treatment zone (C) of said screw extruder, characterized in that, said composite material after being loaded to the extruder in said loading zone (A) is moved along said forming channel (6) of said extruder and is subjected to densification by compacting in said compacting zone (B) by means of decreasing a volume of the said channel space defined between threads (7) of a screw line provided on said screw shaft (2) and/or by means of decreasing a volume of space defined between surface of said screw shaft (2) and a surface of said forming channel (6).

2. The method according to claim 1, characterized in that, the content of said at least one thermosetting resin selected from a group including urea-formaldehyde resins, phenol-formaldehyde resins, melamine-formaldehyde resins, urea-melamine-formaldehyde resins and/or polyether resins used as a binding substance in a composite material, is essentially in the range from about 4% to 30% by weight.

3. The method according to one or more of claim 1 or 2, characterized in that at least one said binding substance is introduced into a filling material using a droplet method, by means of its distribution in a form of drops all over surface of particles of the filling material, preferably by spraying it in the form of drops.

4. The method according anyone of preceding claims, characterized in that, during loading step of said composite material containing from about 4% to 30% by weight of thermosetting resin and a loose material as said filling material, the gravitational feeding method is used.

5. The method according to anyone of claims 1-4, characterized in that, said filling material is composed of wood particles and/or chips and/or short fibre material of plant origin, preferably cellulose fibres and/or natural fibres and/or fibres obtained from natural minerals, preferably basaltic or glass fibres.

6. The method according to anyone of claims 1-5, characterized in that, at least one or more additional substances selected from a group including: catalysts, hydrophobic additives, aseptic additives, anti-friction additives and/or fire retardants are optionally added to said composite material.

7. The method according to anyone of claims 1-6, characterized in that said composite material is heated in said compacting zone (B) to a temperature in the range from about 60° C. to 100° C., and wherein in said heat treatment zone (C) said composite material is heated to a temperature ranging from about 100° C. to 200° C.

8. The method according to anyone of claims 1-7, characterized in that, said densification by compacting of said composite material performed in said compacting zone (B) of said forming channel (6) is performed in a transverse direction to a moving direction of said composite material during extrusion, and optionally in a lengthwise direction, parallel to the lengthwise axis of said screw shaft of said extruder, consistent with moving direction of said composite material during extrusion.

9. The method according to anyone of preceding claims, characterized in that said compacting in a transverse direction and in a lengthwise direction is performed at least partially simultaneously in the same segment of said compacting zone (B).

10. The method according to anyone of preceding claims, characterized in that said composite material is compacted in a lengthwise direction with a compacting ratio in the range from about 1.5 to 2.5 of initial density of said composite material at an entrance of said compacting section (B), while heating up to a temperature ranging from about 30 to 60° C., and said composite material is compacted in a transverse direction with a compacting ratio in a range from about 2 to 4 of initial density while heating up to a temperature not exceeding 100° C.

11. A closed-section beam element, especially in a form of a tubular beam, manufactured by the method according to one or more of claims 1-10 of said composite material containing comminuted and/or broken-up filing material, mainly wooden chips and particles, and thermosetting resin, wherein said beam element (10) has generally longitudinal shape and having cross section of its external contour of any polygonal shape, or a circular or oval shape and/or of any irregular shape, preferably provided with projections and/or recesses arranged over the external surface of said beam element, and additionally said beam element has a central through opening (20) forming an internal through channel, preferably of a circular cross section, wherein surface of the internal through channel is provided with a continuous edge in a form of a contour of at least one screw or spiral line (40) in relation to a centre axis of said beam element and extending, preferably, along full length of the internal channel along its central axis.

12. The beam element according to claim 11, characterized in that a cross section area of said internal through opening is from about 30% to about 80% of entire cross section area of said beam element.

13. An extruding device for manufacturing of closed-profile beam elements, especially tubular beams, of a composite material containing at least one binding substance and filling material comprising comminuted and/or broken-up material of natural origin, especially wood chips and particles and/or short fibre material, which device is provided with a housing, in which a longitudinal internal forming channel (6) surrounded by an external body (3) is arranged, inside said channel a rotational screw shaft (2) is provided that is rotationally supported and arranged centrally along central axis of the forming channel (6), which screw shaft (2) is provided with screw threads arranged on its external surface along at least one screw line, said screw shaft is connected at one of its ends to a power unit (1), and further heating means (4) is located in the device body, wherein said extruding device comprising consecutively located treatment zones, a loading zone (A), a compacting zone (B) and a heat treatment zone (C), characterized in that, in the compacting zone (B), at least at some segment, a volume of said forming channel space defined between said threads (7) of a screw line of said screw shaft (2) decreases and/or a volume of the space limited between surface of said screw shaft (2) and a surface of said forming channel (6) decreases, and furthermore said device is provided with at least two or more feeders (5) delivering composite material to said loading zone (A).

14. The device according to claim 13, characterized in that, said forming channel (6) in said compacting zone (B), at least at a part of its extension, has a cross section area which consecutively decreases in a moving direction of composite material during extrusion.

15. The device according to anyone of claim 13 or 14, characterized in that said surface of said forming channel (6) in the compacting zone (B) defines a shape of a truncated cone or pyramid, a vertex of which facing in a moving direction of composite material during the extrusion.

16. The device according to anyone of preceding claims, characterized in that said surface of said forming channel (6) is provided with at least one or more edges extending along a length of said forming channel (6).

17. The device according to anyone of preceding claims, characterized in that, said screw shaft (2) in said compacting zone (B) at least at a part of said compacting zone extension has variable diameter of its cross section, which consecutively decreases in a moving direction of said composite material during extrusion.

18. The device according to anyone of preceding claims, characterized in that, said forming channel (6) in said compacting zone, at least at a part of said compacting zone (B) extension, having said cross section area consecutively decreasing in a moving direction of said composite material during extrusion, whereas said screw shaft (2) having at least at some segment of this part of said compacting zone consecutively decreasing diameter of its cross section area in a moving direction of said composite material during extrusion.

19. The device according to anyone of preceding claims, characterized in that, said screw shaft (2) in said heat treatment zone (C) having constant diameter of its cross section.

20. The device according to anyone of preceding claims, characterized in that, said forming channel (6) in said heat treatment zone (C) having constant shape and size of its cross section.

21. The device according to anyone of preceding claims, characterized in that said pitch of a screw line of threads of said screw shaft (2) at least at some segment of said loading zone (A) extension and/or compacting zone (B) extension is variable, preferably it consecutively decreases in a moving direction of said composite material during extrusion.

22. The device according to anyone of preceding claims, characterized in that, said screw line of threads of said screw shaft (2) is designed as single-thread, double-thread, triple-threads, quadruple-threads or having more threads.

23. The device according to anyone of preceding claims, characterized in that, said screw shaft (2) is provided with a cooling means and/or a heating means (4).
